(19) United States
(12) Patent Application Publication
(10) Pub. No.: US 2013/0282237 A1
(43) Pub. Date: Oct. 24, 2013

(54) INVERTED PENDULUM TYPE MOVING BODY

(71) Applicants: Ryosuke Nakamura, Hitachinaka (JP); Azusa Amino, Hitachinaka (JP)

(72) Inventors: Ryosuke Nakamura, Hitachinaka (JP); Azusa Amino, Hitachinaka (JP)

(73) Assignee: HITACHI, LTD., Tokyo (JP)

(21) Appl. No.: 13/992,044

(22) PCT Filed: Jan. 12, 2011
(86) PCT No.: PCT/JP2011/050360

§ 371 Date: Jun. 6, 2013

(51) Int. Cl. B60G 17/015

(52) U.S. Cl. CPC B60G 17/015
USPC 701/38

(57) ABSTRACT

An inverted pendulum type moving body has a pair of wheels suspended by a main body of the moving body and arranged in the same plane perpendicular to a direction in which the moving body moves on a floor surface as a traveling surface; a driving mechanism that rotates the wheels; and a driving controller that controls the driving mechanism and thereby maintains an inverted state of a moving robot body. The inverted pendulum type moving body includes a wheel rotational speed measurer that measures rotational speeds of the wheels; a main body front-back direction angular velocity measurer that measures an inclination angular velocity of the main body of the moving body in a front-back direction; suspension actuators that move the wheels in a vertical direction; and a suspension actuator driving unit that drives the suspension actuators.

### TECHNICAL FIELD

The present invention relates to an inverted pendulum type moving body having a traveling stabilization device.

### BACKGROUND ART

As conventional techniques for overpassing a step on a road surface upon a movement of an inverted pendulum type moving body (so-called an autonomous mobile robot), traveling operations have been proposed in Patent Documents 1 and 2 and the like.

For example, Patent Document 1 describes an example in which an inverted pendulum type moving body executes inversion control while causing wheels to contact a step and causing the moving body's center of gravity to move forward, performs drive control of the wheels, and gives torque for overpassing the step.

Patent Document 2 describes an example in which an inverted pendulum type moving body has an obstacle sensor, releases compression of springs in front of a step so as to lift the moving, body, and overpasses the step.

### PRIOR ART DOCUMENT

### Patent Document

Patent Document 1: JP-2009-55682-A
Patent Document 2: JP-2009-35157-A

### SUMMARY OF THE INVENTION

### Problems to be Solved by the Invention

In the aforementioned conventional techniques, however, it is doubtful whether the small inverted pendulum type moving bodies that move at high speeds can reliably overpass a step.

In addition, since the small inverted pendulum type moving body that moves at high speeds receives a large effect from an external environment, it needs to detect a small step. There is, however, a disadvantage that the volume of a general high-precision sensor is large.

Since wheel driving torque becomes small due to miniaturization of the inverted pendulum type moving bodies, there is a problem that a margin of torque to be used to maintain an attitude of an inverted pendulum upon overpassing the step is small.

For example, in the technique described in Patent Document 1, the position of a step is acquired from an optical sensor or deviations of rotational angles of the wheels. In this case, the optical sensor has a trade-off between the detection accuracy of a step and a distance between the step to be detected and the optical sensor and detects a small step only at close range in general. Thus, there is a problem that an operation may not be performed in time upon the detection of the step or the step cannot be detected. If the rotational angles of the wheels are used, deviations of the rotational angles of the wheels may occur and whereby an erroneous detection may be performed.

In addition, in the technique described in Patent Document 2, energy stored in the elastic bodies is used to lift up the moving body when the moving body almost reaches a step. Thus, it is difficult to assist the moving body on the basis of the height of the step. In some cases, the wheels may be dragged by the moving body, be lifted and run idle above a surface.

An object of the present invention is to provide an inverted pendulum type moving body provided with a traveling stabilization device that reliably detects a step, reduces torque required to overpass the step, and achieves stable travel.

### Means for Solving the Problem

The aforementioned object is accomplished by an inverted pendulum type moving body having a pair of wheels that are suspended by a main body of the moving body; a driving mechanism that rotates the wheels; and a driving controller that controls the driving mechanism and thereby maintains an inverted state of the moving robot main body. The inverted pendulum type moving body includes a wheel rotational speed measurer that measures rotational speeds of the wheels; a main body front-back direction angular velocity measurer that measures an inclination angular velocity of the main body of the moving body in a front-back direction; suspension actuators that move the wheels in a vertical direction; and a suspension actuator driving unit that drives the suspension actuators. When the angular velocity, measured by the main body front-back direction angular velocity measurer, of the main body in the front-back direction and the speed of either one of the pair of left and right wheels change by set values or larger, the suspension actuator provided for the wheel of which the speed changes by the set value or larger is driven so as to move up and down the wheel.

In order to accomplish the aforementioned object, it is preferable that the inverted pendulum type moving body further include a main body front-back direction angle measurer that measures an inclination angular velocity of the main body of the moving body in the front-back direction. When the angle, measured by the main body front-back direction angle measurer, of the main body in the front-back direction and the speed of either one of the pair of left and right wheels change by set values or larger, the suspension actuator provided for the wheel of which the speed changes by the set value or larger is driven so as to move up and down the wheel.

In order to accomplish the aforementioned object, it is preferable that the inverted pendulum type moving body further include a wheel driving mechanism that adds driving torque to the wheel moved up on the basis of the amount of the movement of the wheel.

In order to accomplish the aforementioned object, it is preferable that when the inclination angular velocity of the main body of the moving body in the front-back direction or the inclination angle of the main body of the moving body in the front-back direction becomes equal to or lower than a set value, the suspension actuators be driven so that vertical positions of the pair of wheels are the same.

### Effect of the Invention

According to the prevent invention, there can be provided the inverted pendulum type moving body that includes the traveling stabilization device that reliably detects a step, reduces torque required for overpassing the step, and thereby achieves stable travel.

### BRIEF DESCRIPTION OF THE DRAWINGS

FIG. 1 is a diagram illustrating an outline configuration of a conventional inverted pendulum type moving body.

FIG. 2 shows diagrams illustrating an outline configuration of a moving body according to an embodiment of the present invention.

FIG. 3 is a diagram illustrating a system configuration of the moving body according to the embodiment of the present invention.

FIG. 4 is a flowchart of a process to be performed by a traveling stabilization device according to the embodiment of the invention.

### MODE FOR CARRYING OUT THE INVENTION

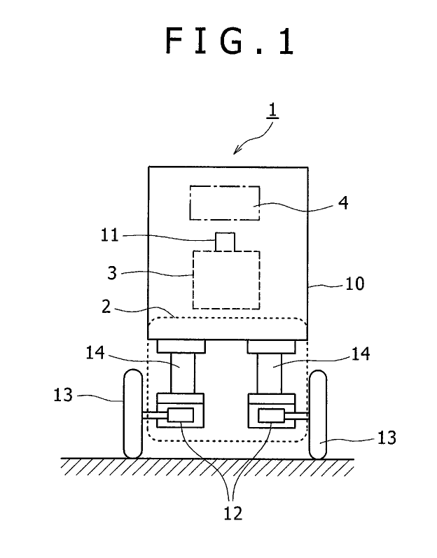

A conventional structure of an inverted pendulum type moving body that is applicable to the invention is described using an inverted pendulum type moving body illustrated in FIG. 1.

FIG. 1 is a diagram illustrating an outline configuration of the conventional inverted pendulum type moving body.

Referring to FIG. 1, the inverted pendulum moving body 1 has a movement mechanism 2 in a main body (chassis) 10 of the moving body. The movement mechanism 2 is controlled by a movement controller 3 and an overpass assist operation generator 4. The inverted pendulum moving body 1 has a gyro 11 in the main body 10 of the moving body as means for acquiring inclination angles in front-back and left-right directions of the main body 10 of the moving body.

The movement mechanism 2 has actuators 14, driving wheels 13 and wheel motors 12 on the left and right of a lower portion of the inverted pendulum moving body 1. The driving wheels 13 that are provided on the left and right of the inverted pendulum moving body 1 are connected to the main body 10 of the moving body through the actuators 14. The actuators 14 are configured to correct an attitude on the basis of an inclination of the main body 10 of the moving body. The driving wheels 13 are driven by the wheel motors 12. The gyro 11 is connected to the movement controller 3 and the overpass assist operation generator 4 by electric signals.

As described above, the conventional inverted pendulum moving body 1 has the actuators 14. Since the actuators 14, however, do not respond to an inclination, caused by a step, of the inverted pendulum moving body 1, the moving body 1 cannot overpass a high step.

The inventors of the invention have considered that the height of a step is detected from a deviation between an inclination angle of the inverted pendulum moving body 1 moving while being inclined and an inclination angle of the inverted pendulum moving body 1 contacting the step, and the driving wheels 13 are lifted up on the basis of the height of the step.

As a result of the consideration, the following embodiment has been obtained.

### First Embodiment

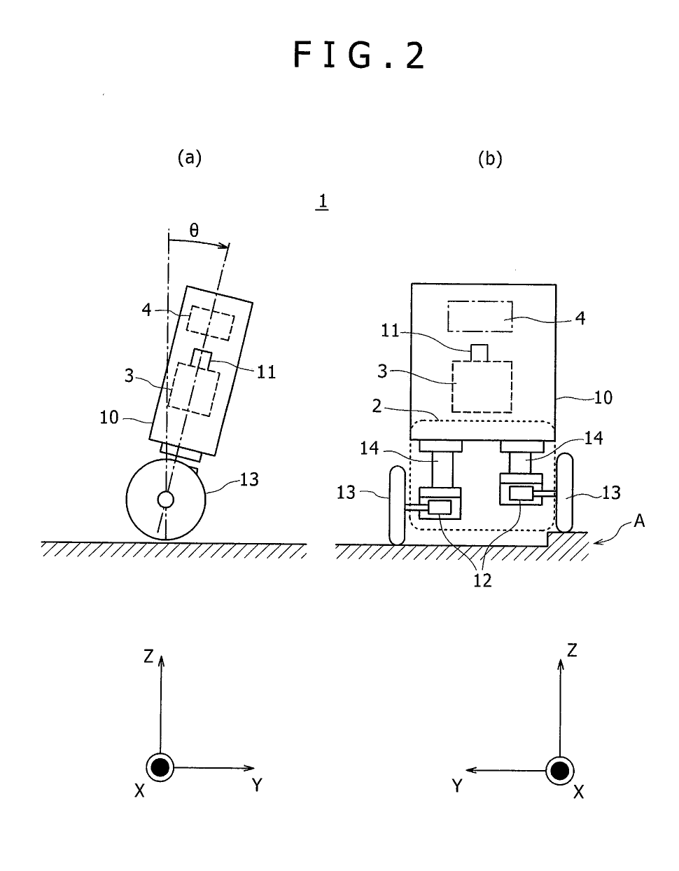

Hereinafter, the embodiment of the present invention is described with reference to FIG. 2.

FIG. 2 shows diagrams illustrating an outline configuration of an inverted pendulum type moving body according to the embodiment of the present invention. FIG. 2(a) is a side view of the inverted pendulum type moving body. FIG. 2(b) is a front view of the inverted pendulum type moving body.

Referring to FIG. 2, the inverted pendulum moving body 1 has a movement mechanism 2 in a main body (chassis) 10 of the moving body. The movement mechanism 2 is controlled by a movement controller 3 and an overpass assist operation generator 4. The inverted pendulum moving body 1 has a gyro 11 in the main body 10 of the moving body as means for acquiring inclination angles in front-back and left-right directions of the main body 10 of the moving body.

The movement mechanism 2 has actuators 14, driving wheels 13 and wheel motors 12 on the left and right of a lower portion of the inverted pendulum moving body 1. The driving wheels 13 that are provided on the left and right of the inverted pendulum moving body 1 are connected to the main body 10 of the moving body through the actuators 14. Distances between the driving wheels 13 and the main body 10 of the moving body can be changed by operating the actuators 14. The driving wheels 13 are driven by the wheel motors 12.

The gyro 11 is connected to the movement controller 3 and the overpass assist operation generator 4 by electric signals. The gyro 11 measures an inclination angle θ and an inclination angular velocity de of the main body 10 of the moving body in the front-back direction with respect to a vertical surface of the main body 10 illustrated in FIG. 2(a).

XYZ coordinate axes illustrated in FIGS. 2(a) and 2(b) are coordinate axes illustrated to ease the description and provided for the main body 10 of the moving body. A positive Y direction is referred to as a front, a negative Y direction as a back, a positive X direction as a right, a negative X direction as a left, and a positive Z direction as a top. The inverted pendulum moving body 1 is capable of moving in the front-back direction. In addition, FIG. 2(b) illustrates a state in which either one of the left and right driving wheels 13 climbs on a step portion A.

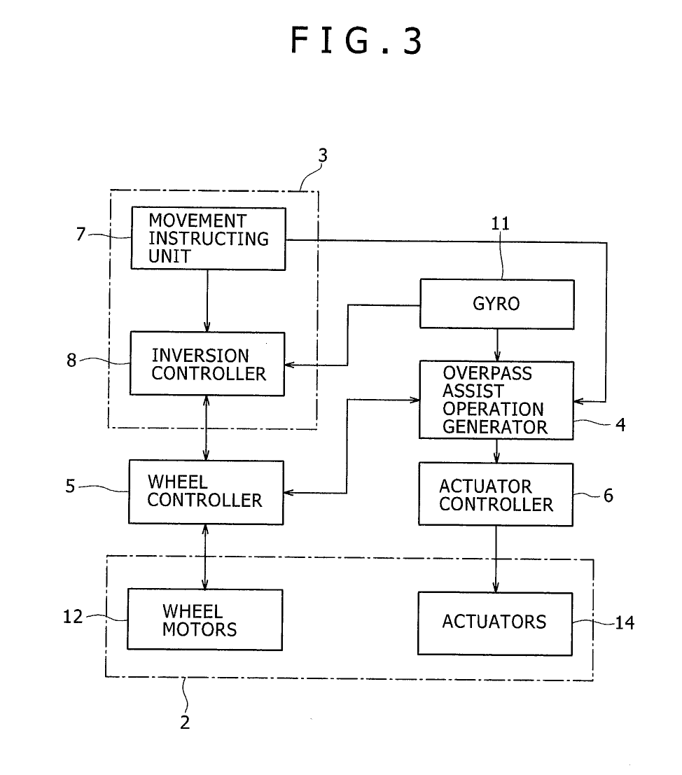

Next, a system configuration is described with reference to FIG. 3.

FIG. 3 is a diagram illustrating the system configuration of the moving body according to the embodiment of the present invention.

Referring to FIG. 3, the movement controller 3 and the overpass assist operation generator 4 form a calculator. The movement controller 3 is connected to the gyro 11, the overpass assist operation generator 4 and the wheel controller 5, and the overpass assist operation generator 4 is connected to the gyro 11, the wheel controller 5 and the actuator controller 6. The movement controller 3 has therein a movement instructing unit 7 and an inversion controller 8 that are implemented as software.

The wheel controller 5 adds inversion torque τi acquired from the movement controller 3 to torque τc given by the overpass assist operation generator and controls the wheel motors 12 so as to cause the wheel motors 12 to output the added torque. In addition, the wheel controller 5 acquires current rotational angles of the wheel motors from the wheel motors 12. The actuator controller 6 receives target lengths from the overpass assist operation generator 4 and controls the actuators 14 so as to cause the actuators 14 have the target lengths.

Processes and operations within the movement controller 3 are described below.

The movement instructing unit 7 generates a target rotational angle θr of the motors 12, a target rotational angular velocity θr, a target inclination angle φr of the main body 10 of the moving body in the front-back direction and a target inclination angle dφr of the main body 10 of the moving body in the front-back direction in accordance with a movement instruction. These components are a target movement trajectory that the inverted pendulum moving body 1 needs to follow.

The movement instruction may be determined by a program in advance or determined in real time by a person using an interface connected to the movement instructing unit 7. In addition, the target rotational angle θr of the driving wheels 13 is obtained by integrating the target rotational angular velocity dθr, and the target inclination angle φr in the front-back direction is obtained by integrating the target inclination angular velocity dφr in the front-back direction.

The target rotational angular velocity dθr can have a trapezoidal pattern, and the target inclination angular velocity in the front-back direction may be constantly 0. The inversion controller 8 acquires the aforementioned target movement trajectory from the movement instructing unit 7, acquires the inclination angle θ of the main body 10 of the moving body in the front-back direction and the inclination angular velocity de in the front-back direction from the gyro 11, acquires the rotational angle θ and rotational angular velocity de of the wheel motors from the wheel controller 5, and calculates the inversion torque τi according to Equation 1.

τᵢ=K1(θr−θ)+K2(dθr−dθ)+K3(φr−φ)+K4(dφr−dφ)

In Equation 1, K1, K2, K3 and K4 are inversion gains and determined using various control theories such as LQR or mechanical learning. If the inversion torque τi is output by the wheel motors 12 and the inverted pendulum moving body 1 is located on a flat, smooth road surface, inversion of the inverted pendulum type moving body 1 can be achieved.

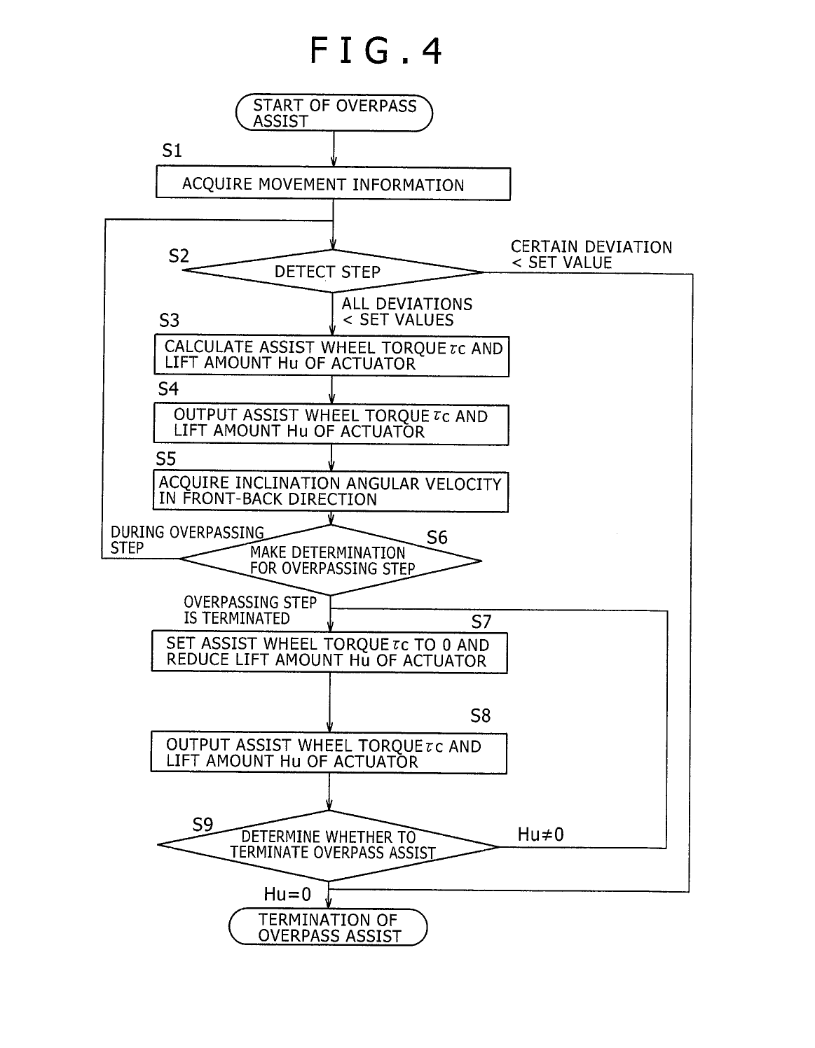

A process, to be performed by the overpass assist operation generator 4 is described using a flowchart of FIG. 4 while attention is paid to only one of the wheels that is likely to contact a step. An operation of overpass assist is performed at a constant period.

FIG. 4 is a flowchart of a process to be executed by the traveling stabilization device according to the embodiment of the present invention.

In S1, the overpass assist operation generator 4 acquires the rotational angular velocity dθ of the wheel motors from the wheel controller 5, acquires the inclination angle φ in the front-back direction and the inclination angular velocity dφ in the front-back direction from the gyro 11, and acquires, from the movement instructing unit, the values dθr, φr and dφr that are the target movement trajectory.

In S2, the overpass assist operation generator 4 calculates the difference between the values dθr and dθ and the difference between the values φr and dφr. If the differences are equal to or larger than set values, the overpass assist operation generator 4 determines that the wheel is in contact with the step portion A illustrated in FIG. 2. If it is determined that the wheel is in contact with the step portion A, the process proceeds to S3. If it is determined that the wheel is not in contact with the step portion A, the overpass assist is terminated.

In S3, the overpass assist operation generator 4 determines the lift amount Hu of the actuator according to Equation 2. Since the actuator 14 is lifted up by the amount Hu, an apparent height of the step portion A for the driving wheel 13 is reduced and the driving wheel 13 can overpass the step portion A with a small amount of energy.

Hu=P1(dθr−dθ)+P2(φr−φ)

In addition, wheel torque τc for overpass assist is determined according to Equation 3. Torque that is required to cause the inverted pendulum type moving body 1 to overpass the step portion A is compensated by the wheel torque τc for overpass assist.

τc=R1(dθr−dθ)+R2(φr−φ)

Symbols P1, P2, R1 and R2 that are used in Equations 2 and 3 are scalar quantities to be used to adjust the lift amount Hu of the actuator and the wheel torque τc for overpass assist and can be empirically determined by an experiment.

In S4, the overpass assist operation generator 4 outputs the lift amount Hu of the actuator to the actuator controller 6 and outputs the wheel torque τc for overpass assist to the wheel controller 5.

In S5, the overpass assist operation generator 4 acquires the inclination angular velocity dθ in the front-back direction and an inclination angular velocity ψ in the left-right direction from the gyro 11.

In S6, the overpass assist operation generator 4 determines whether the inclination angular velocity dθ in the front-back direction is positive or negative. If the velocity dθ is positive, it is determined that overpassing a step has been terminated. If the velocity dθ is negative, it is determined that overpassing the step continues. If overpassing the step is not terminated, the process returns to S2.

In S7, the overpass assist operation generator 4 subtracts a predetermined value from the lift amount Hu of the actuator so as to gradually restore the amount Hu to 0 while maintaining the inclination angle ψ of the main body 10 of the moving body in the left-right direction at 0. This prevents the inverted pendulum type moving body 1 from falling in the left-right direction. In addition, the wheel torque τc for overpass assist is set to 0.

In S8, the overpass assist operation generator 4 outputs the lift amount Hu of the actuator in the same manner as S4 and outputs the wheel torque τc for overpass assist to the wheel controller 5.

In S9, if the lift amount Hu of the actuator is 0, the overpass assist operation generator 4 terminates the overpass assist. If the lift amount Hu is not 0, the overpass assist operation generator 4 returns the process to S7.

Then, the series of processes of the overpass assist is terminated. By restarting the overpass assist on completion of the termination, the process of overpass assist may be constantly performed.

The operation of overpass assist is described while attention is paid to only one wheel that is likely to contact the step portion in FIG. 4. Both wheels, however, may contact a step. In this case, the aforementioned operations are performed for the left and right wheels independently. In addition, when the actuator controller 6 drives the actuators, it operates the actuators so as to accelerate the actuators at an acceleration rate that is equal to or higher than acceleration of gravity.

If both wheels overpass a step simultaneously, loads applied to the driving wheels 13 are reduced and whereby the driving wheels 13 can overpass the step with a smaller amount of wheel torque. In addition, the lift amounts of the left and right actuators for the driving wheels 13 are indicated by Hur and Hul, and the overpass assist operation generator 4 uses the inclination angle (acquired from the gyro 11) in the left-right direction to gradually reduce the lift amounts Hur and Hul of the left and right actuators to 0 in S7 so that the inclination angle ψ of the main body 10 of the moving body in the left-right direction is set to 0. This can prevent the inverted pendulum type moving body 1 from falling in the left-right direction.

Although the embodiment of the present invention is described above, the present invention is not limited to the embodiment, and various modifications can be made for purposes of use and reasons of implementation.

For example, Equation 4 may be used instead of Equation 2.

Hu=P1(dθr−dθ)+P2(φr−φ)+P3(dφr−dφ)

In this case, since a deviation of the inclination angular velocity dφ of the main body 10 of the moving body in the front-back direction is used as compared with Equation 2, the lift amount Hu of the actuator increases at an early stage of the contact with the step. Thus, the moving body 1 can overpass the step while a deviation of the inclination angle θ of the main body 10 of the moving body in the front-back direction is maintained at a small level.

Similarly, Equation 5 may be used instead of Equation 3.

τc=R1(dθr−dθ)+R2(φr−φ)+R3(dφr−dφ)

In this case, since a deviation of the inclination angular velocity dφ of the main body 10 of the moving body in the front-back direction is used as compared with Equation 3, the torque τc for overpass assist increases at an early stage of contact with the step. Thus, moving body 1 can overpass the step more quickly, and the moving speed of the main body 10 of the moving body is less affected by the step.

Symbols P3 and R3 used in Equations 4 and 5 are scalar quantities to be used to adjust the lift amount Hu of the actuator and the wheel torque τc for overpass assist and can be empirically determined by an experiment.

According to the present invention, the following inverted stabilization traveling device can be provided. When the inverted pendulum type moving body travels and overpasses a step, it measures a wheel speed and the angular velocity of the main body in the front-back direction, which are affected by a step in the inverted pendulum type moving body. Then, the moving body determines whether or not the wheel speed and the angular velocity change by set values or larger, and thereby reliably detects the step. Thereafter, the moving body drives an actuator for a wheel of which the speed has changed by the set value or larger, and changes a vertical position of the wheel. Thus, an apparent height of the step for the wheel is reduced, and torque required to overpass the step is reduced. Therefore, stable travel can be achieved.

### DESCRIPTION OF REFERENCE NUMERALS

1 . . . Moving body, 2 . . . Movement mechanism, 3 . . . Movement controller, 4 . . . Overpass assist operation generator, 5 . . . Wheel controller, 6 . . . Actuator controller, 7 . . . Movement instructing unit, 8 . . . Inversion controller, 10 . . . Moving body's main body, 11 . . . Gyro, 12 . . . Wheel motor, 13 . . . Driving wheel, 14 . . . Actuator

1. An inverted pendulum type moving body having: a pair of wheels that are suspended by a main body of the moving body; a driving mechanism that rotates the wheels; and a driving controller that controls the driving mechanism and thereby maintains an inverted state of the moving robot main body; the moving body comprising:
a wheel rotational speed measurer that measures rotational speeds of the wheels;
a main body front-back direction angular velocity measurer that measures an inclination angular velocity of the main body of the moving body in a front-back direction;
suspension actuators that move the wheels in a vertical direction; and
a suspension actuator driving unit that drives the suspension actuators,
wherein when the angular velocity, measured by the main body front-back direction angular velocity measurer, of the main body in the front-back direction and the speed of either one of the pair of left and right wheels change by set values or larger, the suspension actuator provided for the wheel of which the speed changes by the set value or larger is driven so as to move up and down the wheel.

2. The inverted pendulum type moving body according to claim 1, further comprising
a main body front-back direction angle measurer that measures an inclination angle of the main body of the moving body in the front-back direction,
wherein when the angle, measured by the main body front-back direction angle measurer, of the main body in the front-back direction and the speed of either one of the pair of left and right wheels change by set values or larger, the suspension actuator provided for the wheel of which the speed changes by the set value or larger is driven so as to move up and down the wheel.

3. The inverted pendulum type moving body according to claim 1, further comprising
a wheel driving mechanism that adds driving torque to the wheel moved up on the basis of the amount of the movement of the wheel.

4. The inverted pendulum type moving body according to claim 1,
wherein when the inclination angular velocity of the main body of the moving body in the front-back direction or the inclination angle of the main body of the moving body in the front-back direction becomes equal to or lower than a set value, the suspension actuators are driven so that vertical positions of the pair of wheels are the same.

5. The inverted pendulum type moving body according to claim 2, further comprising
a wheel driving mechanism that adds driving torque to the wheel moved up on the basis of the amount of the movement of the wheel.

6. The inverted pendulum type moving body according to claim 2,
wherein when the inclination angular velocity of the main body of the moving body in the front-back direction or the inclination angle of the main body of the moving body in the front-back direction becomes equal to or lower than a set value, the suspension actuators are driven so that vertical positions of the pair of wheels are the same.
